(19) United States
(12) Patent Application Publication
(10) Pub. No.: US 2020/0333884 A1
(43) Pub. Date: Oct. 22, 2020

(54) MOTION FEEDBACK DEVICE

(71) Applicant: University of Kentucky Research Foundation, Lexington, KY (US)

(72) Inventors: Matthew Phillip Ruffner, Lexington, KY (US); Kevin P. Donohue, Lexington, KY (US); Michael J. Sikora, Lexington, KY (US)

(21) Appl. No.: 16/843,542

(22) Filed: Apr. 8, 2020

Related U.S. Application Data
(60) Provisional application No. 62/836,955, filed on Apr. 22, 2019.

(51) Int. Cl. G06F 3/01; G10G 7/00; G10G 1/00; G09B 15/00; G08B 1/08

(52) U.S. Cl. CPC G06F 3/016; G10G 7/00; G08B 1/08; G09B 15/00; G10G 1/00

(57) ABSTRACT

A motion feedback device includes a housing, a speaker and a control module carried by the housing. The control module includes a controller and a motion sensor. The controller is configured to produce different audio feedback through the speaker in response to different user-produced movement of the housing. In addition, the optical and haptic feedback can be used to direct motion to achieve desired sound patterns (music). One or more embodiments of the device provide different audio, visual and haptic feedback in response to different user-produced motions and positions of the housing as well as direct motion to achieve a particular sound.

### RELATED APPLICATION

This application claims priority to U.S. Provisional Patent Application Ser. No. 62/836,955 filed on Apr. 22, 2019 which is hereby incorporated by reference in its entirety.

### TECHNICAL FIELD

This document relates generally to a programable electronic device that functions as an interface for creating sound through motion with audio, visual and/or haptic feedback.

### BACKGROUND

People more readily engage in activities that exhibit noticeable progress, and progress is enhanced through coaching/teaching that provides appropriate and timely feedback. The motion feedback device disclosed in this document is targeted at providing this kind of feedback for musical and physical achievements. This intelligent device transforms kinetic details of specific positions, gestures, motions into acoustic, visual and haptic details that can be more easily perceived by the human brain. The device is programmable and the motion-position transformations and feedback details can be tailored to help the user better understand the context of a specific motion, or the precision with which the specific motion was achieved.

Potential applications of the motion feedback device include, but are not limited to: musical instruction and composition, sports training, physical rehabilitation and music therapy.

### SUMMARY

In accordance with the purposes and benefits described herein, a motion feedback device is provided. That motion feedback device comprises a housing, a speaker and a control module carried by the housing. The control module includes a controller and a motion sensor. The controller is configured to produce different audio feedback through the speaker in response to different user-produced movement of the housing.

The device may include (a) a power source carried by the housing, (b) a cord adapted to carry power from a remote device such as a battery pack or an electrical wall outlet to the device or (c) both of these features.

In one or more of the many possible embodiments of the device, the speaker may be carried by the housing. In one or more of the many possible embodiments of the device, the speaker may be positioned remote from the housing. Where the speaker is remotely positioned, the control module may include a wireless communication feature allowing wireless communication between the controller and the speaker. In one or more of the many possible embodiments of the device, the speaker includes an amplifier that drives the speaker to produce sound.

In one or more of the many possible embodiments of the device, the motion sensor is at least one accelerometer.

In one or more of the many possible embodiments of the device, the control module further includes a laser, such as a laser pointer, adapted or configured to provide remote visual feedback: that is, a visual indication of the physical feature in the environment toward which the device is pointed.

In one or more of the many possible embodiments of the device, the device further includes a haptic feedback element. In such a device, the controller is configured to produce different haptic feedback through the haptic feedback device in response to the different user-produced movement of the housing.

In one or more of the many possible embodiments of the device, the device further includes a visual display. That visual display may be carried on the housing, remotely located from the housing or both.

In one or more of the many possible embodiments of the device, the device includes one or more control actuators, such as knobs, slides or pushbuttons carried on the housing. Those control actuators allow the operator to adjust the operation of the device including, but not necessarily limited to the various audio, visual and/or haptic feedback features of the device.

In one or more of the many possible embodiments of the device, the device includes a band connected to the housing and adapted to secure the housing of the device in a desired place such as to a limb (arm or leg) of the user.

In accordance with an additional aspect, a method of physical rehabilitation is provided. That method comprises the steps of: (a) using the motion feedback device described in this document to provide audio feedback, haptic feedback, visual feedback or any combination thereof resulting from a user-produced motion and (b) comparing the feedback so produced to a benchmark feedback representative of a desired motion to be emulated by the user.

In accordance with yet another aspect, a method of sport training is provided. That method includes the steps of: (a) using the motion feedback device described in this document to provide audio feedback, haptic feedback, visual feedback or any combination thereof resulting from a user-produced motion characteristic of a particular sport and (b) comparing the feedback so produced to a benchmark feedback representative of a desired motion to be emulated by the user.

In accordance with yet another aspect, a new and improved motion feedback device comprises: (a) a housing, (b) an audio feedback element, such as an amplifier and speaker, headphones and/or ear buds, (c) a visual feedback element, such as a laser, laser pointer and/or display monitor, (d) a haptic feedback element, such as force, vibrotactile, and/or electrotactile actuators and (e) a control module. The control module includes a controller and a motion sensor. The motion sensor senses the user-produced movement of the housing while the controller is configured to produce (a) different audio feedback through the audio feedback feature, (b) different visual feedback through the visual feedback element and different haptic feedback through the haptic feedback element in response to the different user-produced motion or movement of the housing sensed by the motion sensor.

Still further, a method of music creation is provided. That method includes the steps of: (a) using the motion feedback device to provide visual and haptic feedback representative of the user-produced motion and special orienting of the motion feedback device and (b) generating audio feedback as the music creation in response to the user-produced motion and the special-orienting of the motion feedback device.

In the following description, there are shown and described several preferred embodiments of the motion feedback device and the related methods of physical rehabilitation and sport training. As it should be realized, the motion feedback device and the related methods are capable of other, different embodiments and their several details are capable of modification in various, obvious aspects all without departing from the motion feedback device and methods as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the patent specification, illustrate several aspects of the method and together with the description serve to explain certain principles thereof.

FIG. 1 is a perspective view of one possible embodiment of the motion feedback device.

FIG. 2 is a schematic block diagram of one possible embodiment of the motion feedback device providing different audio, visual and haptic feedback in response to different user-produced movement or motion of the device.

FIG. 3 is an illustration of the motion feedback device configured for enhancing or improving a user's golf swing.

FIG. 4 is a schematic block diagram of another possible embodiment of the motion feedback device wherein the device is configured or adapted for sports training.

FIG. 5 is an illustration of the motion feedback device configured for physical rehabilitation and, more specifically, for restoring range of arm motion of the user.

FIG. 6 is a schematic block diagram of a remotely located companion component which forms a part of an alternative embodiment of the motion feedback device used for physical rehabilitation.

FIG. 7 is a perspective view of a USB data/power interface for the companion component illustrated in FIG. 6.

FIG. 8 is a schematic block diagram of another possible embodiment of the motion feedback device wherein the device is configured for music therapy.

FIG. 9 is a perspective view of one possible embodiment of the motion feedback device adapted for music therapy and bilateral stimulation.

### DETAILED DESCRIPTION

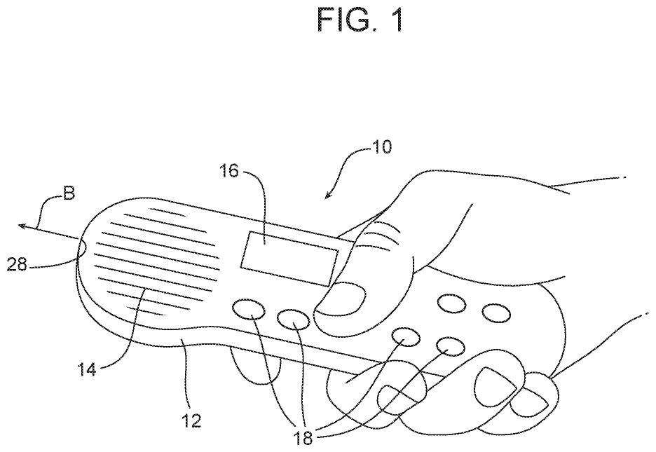

Reference is now made to FIG. 1 which illustrates one possible embodiment of a motion feedback device 10 that may be configured to provide users with one or more modes of feedback before, during and after certain user-produced positions and motions have been achieved. Thus, the device 10 facilitates a multisensory understanding of the quality and accuracy with which the motion was performed or the position achieved.

As will become apparent from the following description, the device 10 may be programmed to convert a movement, described by motion and position parameters (either from a specific motion, series of motions, or arbitrary movement), to a particular feedback fingerprint. A feedback fingerprint is a combination of haptic, acoustic, and visual feedback that allows the user to intuitively perceive a richer set of details about the performed movement. The way in which the feedback fingerprint is generated can vary and be adjusted for multiple applications and markets.

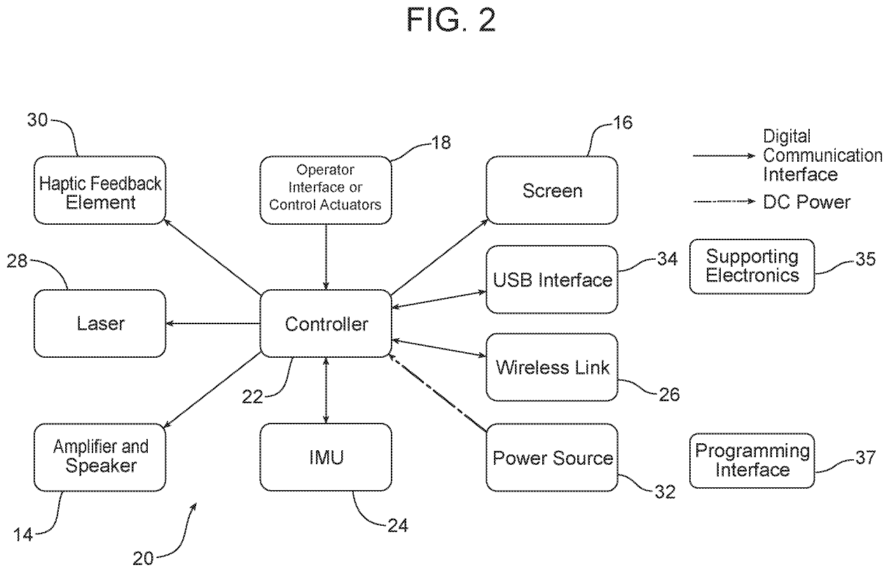

As illustrated in FIGS. 1 and 2, the motion feedback device 10 includes a housing 12 made from any appropriate, lightweight material. The housing 12 carries an amplifier and speaker 14, a display screen 16 and various operator interface or control actuators 18, which may take the form of buttons, knobs, slides or other human interface devices adapted to allow a user to adjust the operation of the device 10 as desired.

The motion feedback device 10 also includes a control module that is illustrated in FIG. 2 and generally designated by reference numeral 20. More specifically, the control module 20 includes a controller 22, a motion sensor 24, and a wireless communication feature 26 of a type known in the art that is adapted for wireless communication.

The controller 22 may comprise a computing device, such as a dedicated microprocessor or an electronic control unit (ECU) operating in accordance with instructions from appropriate control software. Thus, it should be appreciated that the device 10 may incorporate hardware and/or software control. In at least one possible embodiment, the controller 22 comprises one or more processors, one or more memories and one or more network interfaces all in communication with each other over one or more communications buses.

The motion sensor 24 may comprise one or more accelerometers or other motion sensor devices of a type known in the art and adapted to sense, in real time, the user-produced movement or motion of the housing 12.

The motion feedback device 10 may also include a laser 28, such as a laser pointer of the type well known in the art (note laser 28 and laser beam B in FIG. 1). The laser 28 is adapted to provide remote visual feedback: that is, a visual indication of the physical feature in the environment toward which the device 10 is pointed.

The motion feedback device 10 may also include a haptic feedback element 30, of a type known in the art to provide any desired haptic feedback to the user. Haptic feedback elements 30 include, but are not necessarily limited to vibration motors, piezoelectric and linear actuators, stepper motors, air vortex rings, skin electrodes and combinations thereof. In any embodiment including the haptic feedback element 30, the controller 22 may be configured to produce different haptic feedback through the haptic feedback element in response to the different user-produced movement or motion of the housing 12.

As illustrated in FIG. 2, the motion feedback device 10 may include a power source 32, such as, for example, batteries or capacitors carried by the housing 12. Alternatively or in addition, the device 10 may include a power cord (not shown) adapted for connection to a remotely located power source such as, but not necessarily limited to a battery pack or an electrical wall outlet.

As further illustrated in FIG. 2, the housing 12 of the device 10 may also carry a USB interface 34 that allows for direct physical connection, via a USB cord, of the controller 22 carried by the housing to remotely located electronic devices such as a remotely located speaker, a visual display, a computer or the like.

The motion feedback device 10 has a number of potential applications including, for example, music education and entertainment. In this application, the object is the sound created (musical), and the remote visual feedback is provided by the laser 28 and the haptic feedback provided by element 30 are used to direct the position and timing of the motion for this purpose. More specifically, the laser 28 is used to point at objects associated with musical notes on a staff or classroom whiteboard. Feedback from the haptic feedback element 30 then provides pulses, patterns, and fluctuating levels of vibration, force, or electrotactical stimulation to give the user complementary signals related to the musical/educational object. Haptic feedback in this case is given to the user when a proper technique is achieved or to maintain timing. The device 10 allows novice users to perform simple musical expressions quickly, while also allowing complex musical expressions with practice.

For instructional use the device 10 may be handheld and used by teachers and students. Collaboration and composition would be capable if both students and teachers were equipped with a set of these devices 10. The wireless communication feature 26 allows for simultaneous musical collaboration, where multiple devices 10 communicate to share a synchronized metronome signal. This can be computer driven or master control given to the teacher. The students can feel this metronome signal with haptic feedback from the haptic feedback element 30. The remote visual feedback can be directed by the instructor as well, where students follow the positions pointed to by the teacher. The wireless communication feature 26 can also be used to transmit information about each device's feedback state. Any given device 10 can also receive and combine the feedback fingerprints of each transmitting device for a symphony-like effect. The wireless communication feature 26 also facilitates musical composition, where the students' notes are sent to a computer through a designated receiving device and displayed upon a musical score.

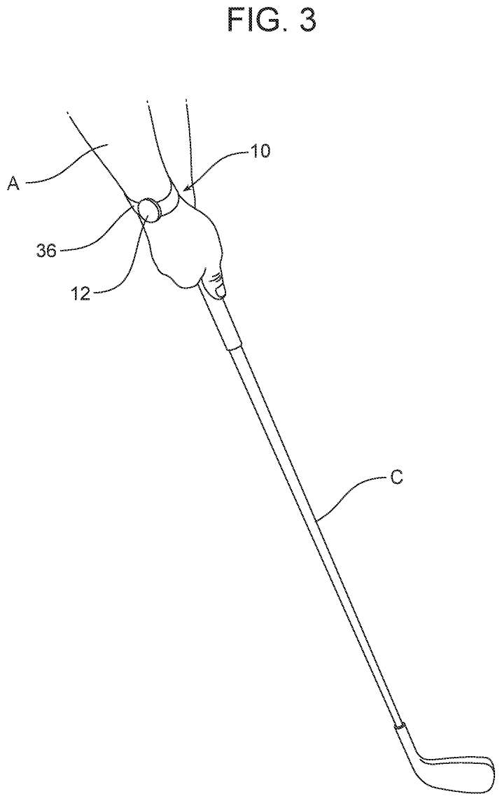

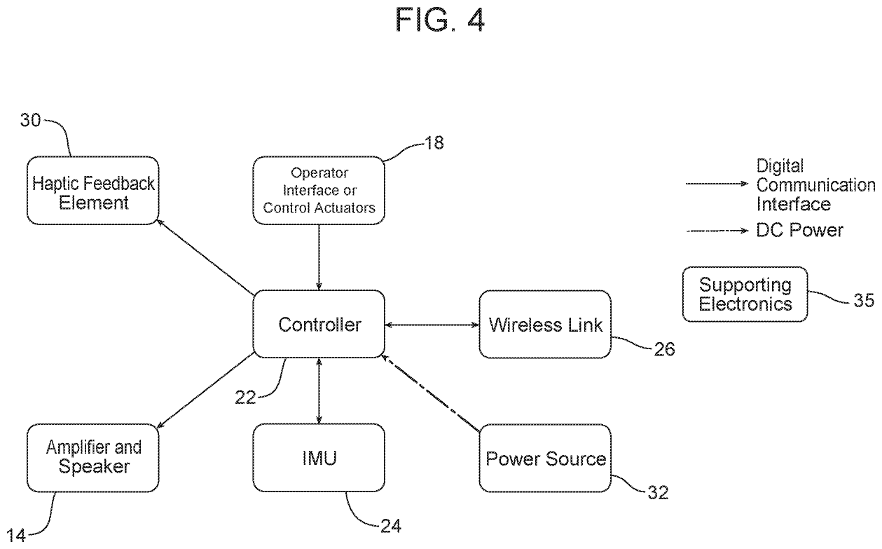

Reference is now made to FIGS. 3 and 4 which illustrate a device 10 used in a method of sport training. As illustrated in FIG. 3, the device 10 may be secured to the lower arm or wrist A of the user by means of a band 36 connected to the housing 12, or may be secured to another relevant body position or position on the club, bat, or racket. The band 36 may be, for example, an elastic band or a strap with a securing buckle.

For purposes of this application, the motion feedback device 10 may include the controller 22 connected to the amplifier and speaker 14, the motion sensor 24 and the haptic feedback element 30 all carried by the housing. The housing 12 may also carry (a) a rechargeable power source 32, (b) operator interface or control actuators 18, such as buttons, knobs, slides or the like, to adjust the operation of the device 10 and (c) the wireless communication feature 26 allowing wireless communication, such as Bluetooth communication between the controller 22 held in the housing 12 and remotely located supporting electronic devices such as a display monitor, personal computer or the like (not shown). In some embodiments, the amplifier and speaker 14 may also be remotely located instead of being carried by the housing 12 in order to reduce the packaging requirements and the size of the housing.

The motion feedback device illustrated in FIGS. 3 and 4 would be used to imitate or repeat the desired, proper motion of swinging the golf club C online. The fast motions associated with the golf swing are hard to observe visually, however, when the motion is sonified (auralization) to provide another input to another human sense, that helps in recognizing proper physical form.

While the sport training device 10 illustrated in FIGS. 3 and 4 relates to golf, it should be appreciated that the device 10 may be easily adapted for training in other sports such as, for example, tennis to improve one's swing, soccer to improve one's kicking stroke (by connection of the device 10 to the kicking leg), running by connection of multiple devices to the arms and legs, etc.

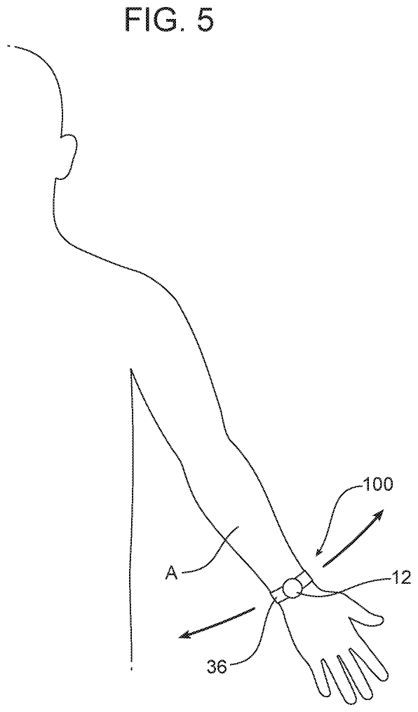

Reference is now made to FIG. 5 which illustrated a device used for physical rehabilitation. For this application, a user is either home or at a clinical physical rehabilitation session.

More specifically, the device 10 would consist of at least two components 100 and 200. The first component 100 would be worn on-body, mounted with limited intrusion to arm or leg or other artifact, with a compact, ergonomic design. See, for example, FIG. 5 showing the first component 100 of the device 10 attached to the arm A of the user by a band 36 connected to the housing 12. For some applications, the device 10 may include more than one component 100 worn on one or more limbs of the user. Those components 100 would provide combined feedback on all of the inputs from each limb upon which a device is worn. Such a device 10 supports complex rehab where more than one joint, limb, artifact, or prosthesis are involved. The wearable device 10 or first component 100 for this application may be the same as that for the device for sports training illustrated in FIG. 4.

The second component 200 is non-battery powered and stationary, and may be connected to the first component 100 wirelessly. The second component 200 would use information from the first component or components 100 to provide the user with enhanced contextual feedback.

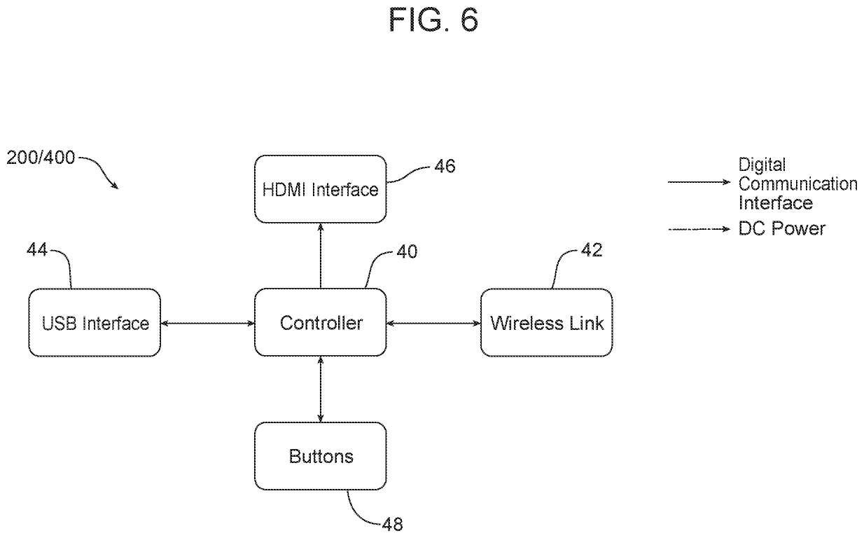

More specifically, as illustrated in FIG. 6, the second component 200 may include (a) a computing device 40 connected to a complimentary wireless communication feature 42, allowing wireless communication with the wireless communication feature 26 of component 100, (b) a USB interface 44, (c) a HDMI interface 46, allowing HDMI connection to devices such as a video monitor (not shown) and (d) control actuators 48, including various human interface features such as buttons, knobs or slides to allow operator adjustment of the second component 200. The second component 200 may include a power cord (not shown) for connection to a power source such as an electrical wall outlet or a rechargeable power source or both.

In this application, remote visual and acoustic feedback is provided by the capabilities of the second component 200 which has capability to drive a display and inform the user on a monitor or projector. Component 200 also has connectivity such that it can attach to a personal computer (PC) and supply the remote visual feedback information to the PC over the USB interface 44 for purposes of data compilation, processing and analysis.

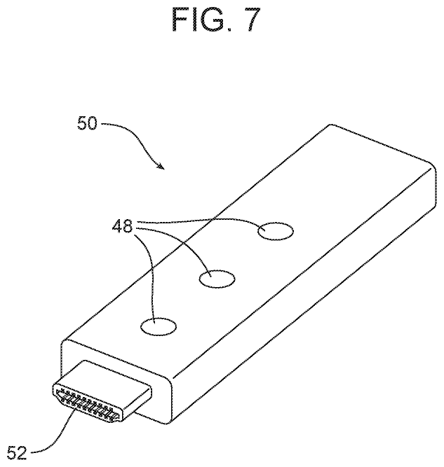

As illustrated in FIG. 7, the second component 200 may take the form of a USB data/power interface or stick 50 that may be directly connected to a personal computer through the connector 52.

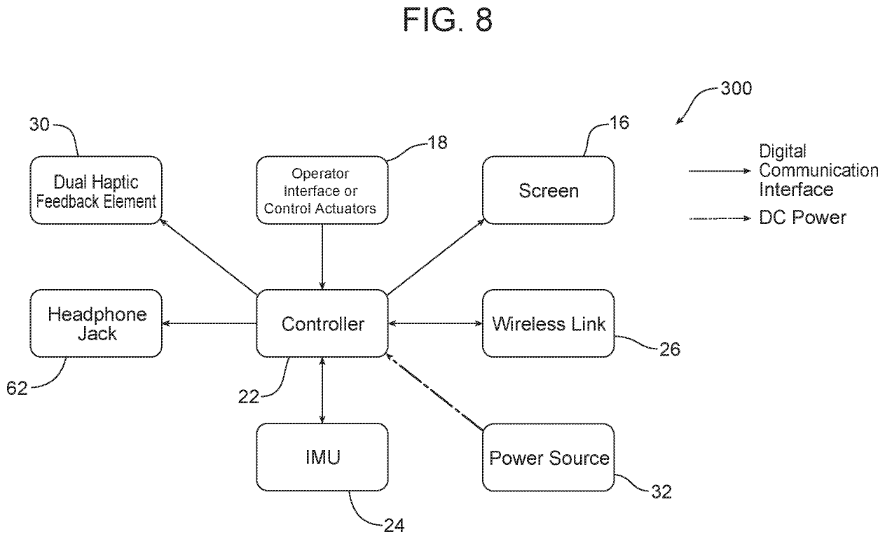

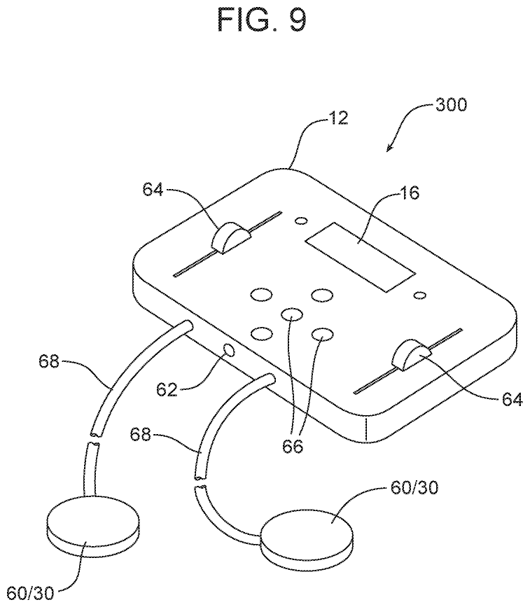

The device 10 may also be used for music therapy. For this application, the device 10 may once again include two components 300 and 400. The first component 300 illustrated in FIGS. 8 and 9 is a handheld device including a controller 22 connected to a motion sensor 24, a wireless communication feature 26, dual haptic feedback elements 30 in the form of two sealed vibrating pads 60, operator interface control slides 64 and buttons 66, a display screen 16, a headphone jack 62 and a rechargeable power source 32 all carried in a handheld housing 12.

In this embodiment of the device 10, haptic feedback is externalized in stereo to the two pads 60 at the end of the leads 68. Two channel (stereo) speakers or headphones (not shown) connected to the controller 22 through the headphone jack 62 or the wireless communication feature 26 are used to also provide dual channel acoustic feedback in this scenario as well. The second component 400 may be similar to the second component 200 illustrated in FIG. 6. Thus, remote visual feedback may be provided on a video monitor (not shown) connected to the HDMI interface 46.

The device 10 illustrated in FIGS. 6, 8 and 9 is then able to be used for bilateral stimulation, a core element of eye movement desensitization and reprocessing (EMDR) therapy, and also a common treatment for post-traumatic stress disorder (PTSD). Alternating left and right channel feedback is known to induce a calming effect in patients. The patient can observe patterns displayed on a TV or monitor (not shown) connected to the HDMI interface 46 of the second component 400. As noted above, the other forms of bilateral feedback available to the patient are haptic and auditory. Haptic is provided by the pads 60 that are held in the hands. A stereo headset connected to the device via the headphone jack 62 may be used for bilateral acoustic feedback. The user can also choose to combine several forms of feedback for themselves with the onboard device controls 64,66.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A motion feedback device, comprising:
a housing;
a speaker; and
a control module carried by said housing, the control module including a controller and a motion sensor wherein the controller is configured to produce different audio feedback through the speaker in response to different user-produced movement of the housing.

2. The motion feedback device of claim 1, wherein the speaker is also carried by the housing.

3. The motion feedback device of claim 1, wherein the control module includes a wireless communication feature allowing wireless communication between the controller and the speaker located remote from the housing.

4. The motion feedback device of claim 1, wherein said speaker includes an amplifier driving the speaker.

5. The motion feedback device of claim 1, further including a laser for remote visual feedback.

6. The motion feedback device of claim 1, wherein the motion sensor is at least one accelerometer.

7. The motion feedback device of claim 6, further including a haptic feedback element wherein the controller is further configured to produce different haptic feedback through the haptic feedback element in response to the different user-produced movement of the housing.

8. The motion feedback device of claim 7, further including a power source carried by said housing.

9. The motion feedback device of claim 8, further including a visual display.

10. The motion feedback device of claim 9, wherein said visual display is carried by the housing.

11. The motion feedback device of claim 10, further including at least one control actuator carried on the housing.

12. The motion feedback device of claim 1, further including a haptic feedback element wherein the controller is further configured to produce different haptic feedback through the haptic feedback element in response to the different user-produced movement of the housing.

13. The motion feedback device of claim 1, further including a power source carried by said housing.

14. The motion feedback device of claim 1, further including a visual display.

15. The motion feedback device of claim 1, further including a band connected to the housing and adapted to secure the housing to a limb of a user.

16. A method of sport training, comprising:
using the motion feedback device of claim 1 to provide audio feedback of a user-produced motion characteristic of a particular sport; and
comparing said audio feedback to a benchmark audio file representative of a desired motion to be emulated by the user.

17. A method of physical rehabilitation, comprising:
using the motion feedback device of claim 1 to provide audio feedback of a user-produced motion; and
comparing said audio feedback to a benchmark audio file representative of a desired motion to be emulated by the user.

18. A motion feedback device, comprising:
a housing;
an audio feedback element;
a visual feedback element;
a haptic feedback element; and
a control module carried by the housing, the control module including a controller and a motion sensor wherein the controller is configured to produce (a) different audio feedback through the audio feedback feature, (b) different visual feedback through the visual feedback element and (c) different haptic feedback through the haptic feedback element in response to different user-produced movement of the housing.

19. The motion feedback device of claim 18, wherein said visual feedback element is a laser pointer.

20. A method of music creation, comprising:
using the motion feedback device of claim 18 to provide visual and haptic feedback representative of user-produced motion and spatial orienting of the motion feedback device; and
generating audio feedback as the music creation in response to the user-produced motion and the spatial orienting of the motion feedback device.
